(19) United States
(12) Patent Application Publication
(10) Pub. No.: US 2023/0278033 A1
(43) Pub. Date: Sep. 7, 2023

(54) A DEVICE, A SURFACE, AND A BIOSENSOR

(71) Applicants: IMEC VZW, Leuven (BE); Katholieke Universiteit Leuven, Leuven (BE)

(72) Inventor: Christopher Chare, Kessel-Lo (BE)

(21) Appl. No.: 18/007,498

(22) PCT Filed: Jul. 1, 2021
(86) PCT No.: PCT/EP2021/068226

§ 371 Date: Jan. 31, 2023

(30) Foreign Application Priority Data
Jul. 31, 2020 (EP) 20188793.2

(51) Int. Cl. B01L 3/00

(52) U.S. Cl. CPC B01L 3/50273; B01L 2300/0809; B01L 2300/089; B01L 2300/166; B01L 2400/0439; B01L 2400/088

(57) ABSTRACT

A device for manipulating a droplet comprising water is provided, the device including: (i) a surface configured to support the droplet, the surface including a hydrophobic region; and (ii) an ultrasound transducer array, the ultrasound transducer array being arranged above the surface and separated from the surface; wherein the ultrasound transducer array is configured to emit ultrasound for actuating a motion of the droplet along the surface by subjecting the droplet to an acoustic radiation force by the emitted ultrasound.

### TECHNICAL FIELD

The present invention relates, in general, to manipulation of droplets comprising water and, more particularly, to manipulation of droplets comprising water and a biological component.

### BACKGROUND

Manipulation of liquid water samples is a common task in various sensors, e.g. biosensors. By manipulating a liquid water sample, it may be moved, mixed, split, or compelled to react with other liquid water samples or reagents. It may be desirable to manipulate small volumes of liquid water samples, e.g. to increase speed of reactions and/or reduce cost of reagents and power consumption.

One way of manipulating small liquid water samples is through the use of a microfluidic device, wherein the liquid water sample flows through miniature channels.

Yet another way of manipulating small liquid water samples is through the use of an electrowetting device. An electrowetting device may sandwich a droplet between a bottom array of electrodes and a common top contact. By applying a potential difference across the droplet via the top contact and an electrode of the array of electrodes, the droplet may be moved from one electrode to another. In order to handle very small droplets, the spacer between the bottom array of electrodes and the top contact of the electrowetting device may need to be very small.

The miniature channels of microfluidic devices and the spacer between the array of electrodes and the top contact of electrowetting devices may be confined spaces which are hard to manufacture, especially over large areas. Such confined spaces may further give rise to capillary action and laminar flow which may prevent mixing of droplets. Thus, there is still room for alternative and/or improved devices.

### SUMMARY

It is an objective of the invention to enable manipulation of a small water comprising sample. It is a further objective of the invention that the water comprising sample can be manipulated accurately. It is a further objective of the invention that the water comprising sample can be manipulated over a large area. It is a further objective of the invention that contamination of the manipulated water comprising sample is low. It is a further objective of the invention that cost of manipulating the water comprising sample is low. These and other objectives of the invention are at least partly met by the invention as defined in the independent claims. Preferred embodiments are set out in the dependent claims.

According to a first aspect of the invention, there is provided a device for manipulating a droplet comprising water, the device comprising:
a surface configured to support the droplet, the surface comprising a hydrophobic region;
an ultrasound transducer array, the ultrasound transducer array being arranged above the surface, and separated from the surface; wherein the ultrasound transducer array is configured to emit ultrasound for actuating a motion of the droplet along the surface by subjecting the droplet to an acoustic radiation force by the emitted ultrasound.

The device may be configured to actuate the motion of the droplet along the surface across the hydrophobic region. The hydrophobicity may then ensure that the contact angle between the droplet and the hydrophobic surface of the hydrophobic region is large. Thus, the droplet may move more easily along the surface, e.g. roll along the surface due to the large contact angle. Alternatively, the hydrophobic region may act as a barrier to the droplet, thereby preventing unwanted movements of the droplet.

A hydrophobic region of the surface may be a region in which a pure water droplet forms a contact angle to the surface of more than 90 degrees.

The droplet that is manipulated may not be a pure water droplet. The droplet may further comprise matter dissolved, suspended, or immersed in the water. Further matter comprised in the droplet may be biological components, e.g. cells, or reagents that react with biological components, e.g. antibodies. The droplet may thus be a transporter of further matter, in addition to water.

The ultrasound transducer array may be an array of micromachined ultrasound transducers. The micromachined ultrasound transducers may be piezoelectric micromachined ultrasound transducers or capacitive micromachined ultrasound transducers. The separation between the ultrasound transducer array and the surface may be larger than the height of the droplet, the separation may e.g. be 10 mm or 50 mm. The ultrasound transducer array may be an ultrasound transducer phased array, wherein the phases of at least a subset of the ultrasound transducers are adjustable. By setting the phases of the different ultrasound transducers, it is possible to control how the ultrasound signals emitted by different ultrasound transducers interfere. Thereby, ultrasound emitted from the ultrasound transducer array may be focused and/or steered. For example, a beam of ultrasound, e.g. a focused beam, may be steered over the surface of the device while actuating a motion of the droplet along the surface, e.g. pushing the droplet along the surface. It should be understood that the ultrasound transducer array does not necessarily have to be an ultrasound transducer phased array. The ultrasound transducers may e.g. have fixed phases such that the focus and direction of the beam relative to the ultrasound transducer array is fixed. In this case, the entire ultrasound transducer array may be moved relative to the surface, thereby moving the ultrasound beam along the surface.

The acoustic radiation force may be a force arising from the ultrasound scattering off the droplet.

The device may be configured to actuate the motion of the droplet by applying an acoustic radiation force to the droplet through focusing an ultrasound field from the ultrasound transducer array on the droplet. The ultrasound field may be focused on one side of the droplet, whereby the droplet may be pushed away from the focused ultrasound field. The device may be configured to emit ultrasound continuously. The ultrasound beam may herein be focused on one side of the droplet and steered to move along with the droplet, whereby the droplet is pushed in front of the moving focal point. Alternatively, the device may be configured to emit pulsed ultrasound, whereby the droplet is nudged a distance forward in response to each pulse.

As an alternative to actuating the motion through a focused ultrasound field, the device may be configured to actuate the motion of the droplet by applying an acoustic radiation force to the droplet through trapping the droplet in an acoustic trapping potential, generated by the ultrasound transducer array, and moving the acoustic trapping potential. The acoustic trapping potential may represent the energy needed to move the droplet through the ultrasound field. The acoustic trapping potential may have a local minimum where the droplet preferentially stays, i.e. where the droplet is trapped. When the acoustic trapping potential is moved the droplet may move along, staying at the moving local minimum.

The ultrasound transducer array may emit ultrasound in the frequency range 40 kHz to 2 MHz or 40 kHz to 20 MHz. The ultrasound wavelength in air may thus be as small as 20 μm, making it possible to manipulate very small droplets. In some embodiments the droplets may be smaller than the ultrasound wavelength, in other embodiments the droplets may be larger than the ultrasound wavelength. The droplets may herein be of a size corresponding to a volume of 1 femtoliter to 1 milliliter, e.g. 1-1000 fL, 1-1000 pL, 1-1000 nL, or 1-1000 μL. The device may be configured to have an adjustable frequency or a fixed frequency.

According to the above, the use of ultrasound to actuate a motion of the droplet may enable manipulation of very small droplets. Further, the droplets may be manipulated very accurately. The resolution of the movements may at least be as small as the ultrasound wavelength.

Further, a device according to the inventive concept may manipulate a droplet over a large area. Ultrasound transducer arrays may be very large, e.g. at least 5 by 5 cm. The area over which the droplet is manipulated is not necessarily restricted by the size of the ultrasound transducer array. For example, the ultrasound transducer array be moved mechanically to cover a larger area. When the droplet is moved to a position close to the edge of the ultrasound transducer array the droplet may be parked, the ultrasound transducer array may then be moved to a new position after which it may continue to manipulate the droplet.

Further, as a device according to the inventive concept does not need to confine a droplet, the device may not give rise to capillary action and laminar flow which may prevent mixing of droplets.

Further, a device according to the inventive concept may manipulate a droplet without contaminating it. This may be facilitated as the actuator, the ultrasound transducer array, may not need to be in contact with the droplet. This is in contrast to e.g. an electrowetting device where the droplet is in contact with the electrodes.

Further, the cost of manipulating the droplet may be low. The ultrasound transducer array may of course be reused from sample to sample as it may never come into contact with the sample. The surface may be manufactured at a low cost as it may be of low complexity. The cost of manufacturing the surface may be lower than the cost of manufacturing an electrode array of an electrowetting device or the cost of manufacturing microfluidic channels. The surface may therefore be discarded after one use and replaced with a new one. If the surface is cleaned between uses this may be done at a low cost as there need not be any confined spaces that are hard to access.

The surface of the device may further comprise at least one guiding region, wherein the at least one guiding region has a lower hydrophobicity than the hydrophobic region, such that the droplet has a greater affinity to the at least one guiding region than to the hydrophobic region, whereby the hydrophobic region and the at least one guiding region form a guiding pattern of the surface, wherein the surface is configured to guide motion of the droplet along the surface by the guiding pattern.

The hydrophobic region may thus act as a barrier to the droplet, thereby preventing unwanted movements of the droplet. The guiding region may have a lower hydrophobicity than the hydrophobic region but still be hydrophobic. Thus, the droplet may move, e.g. roll, easily in the guiding region while still being hindered from moving into the hydrophobic region. Alternatively, the guiding region may be hydrophilic. In such a hydrophilic region the droplet may slide rather than roll.

A hydrophilic region of the surface may be a region in which a pure water droplet forms a contact angle to the surface of less than 90 degrees. The guiding pattern may aid the manipulation of the droplet. Thereby, the requirements on the ultrasound transducer array may be relaxed and it may be cheaper to manufacture. An ultrasound transducer array that shapes and/or steers the ultrasound beam in a coarse manner may be enough if a guiding pattern helps to guide the motion of the droplet. For example, if the droplet is pushed forward by a focused ultrasound beam on a uniform surface, the droplet may have a tendency to slip to the side. This may be countered by a feedback system that adjusts the movements of the ultrasound focal point to avoid such unwanted movements. If the surface comprises a guiding pattern the pattern itself may be configured to prevent such unwanted movements and the requirements on the rest of the device may be relaxed.

The guiding pattern may comprise a track, the track having a width and a length, the length being substantially larger than the width, the track being one of the at least one guiding regions of the surface, wherein the hydrophobic region of the surface borders the track on both sides of the track, along the length of the track,
whereby the guiding pattern is configured to guide the motion of the droplet by favoring movement of the droplet along the track.

The track may thus guide the motion of the droplet along the length of the track. The track may thereby guide the motion of the droplet either forwards or backwards along the length of the track. The track may thereby guide the motion of the droplet such that it is prevented from moving off the track in the width direction. Thus, the droplet may have a greater affinity to moving on the track than to moving off the track. The track may thereby form a path for the droplet. The track may be configured to have a width on the same size order as the size of the droplet the device is configured to manipulate. For example, if the device is configured to manipulate droplets with a diameter of D, the width of the track may be in the range of 0.01 D to 4 D, or in the range of 0.1 D to 0.5 D. The track may be hydrophobic, albeit less hydrophobic than the bordering hydrophobic region.

The track may be formed by a periodical repetition of a first part of the track and a second part of the track along the length of the track,
wherein, in a direction along the length of the track, the width of the track narrows, in the first part of the track, from a maximum width to a minimum width, after which the width of the track widens, in the second part of the track, from the minimum width to the maximum width,
wherein, in the periodical repetition, the second parts of the track are shorter than the first parts of the track.

Thus, the guiding pattern may be configured to guide the motion of the droplet by presenting a preferential direction of movement to the droplet.

In an embodiment, the track may thus look like the track illustrated in FIG. 3, which will be referred to in the coming discussion. When the track 40; narrows slowly from a maximum width 43 to a minimum width 44 in the first part 41 of the track 40, and then widens abruptly from the minimum width 44 to the maximum width 43 in the second part 42 in a direction 45 along the length of the track 40; the droplet 2 may preferentially move in the said direction 45. Thus, the track 40 may work as a ratchet. The droplet 2 may be prevented from moving in a direction opposite to the direction 45 when a potential energy barrier to overcome the abrupt change in width is high. Thus, the track 40 may be configured such that the force needed to move the droplet 2 in a direction opposite to the direction 45 is larger than the force needed to move the droplet 2 in the direction 45. Thereby, the preferential direction of movement for the droplet 2 may be the direction 45 along the length of the track. However, it should be understood that in some embodiments the preferential direction of movement for the droplet 2 may be a direction opposite to the direction 45 along the length of the track that is illustrated in FIG. 3. For example, when the difference between the maximum width 43 and the minimum width 44 is small, the preferential direction of movement for the droplet 2 may be a direction opposite to the direction 45 along the length of the track. Thus, the track 40 may be configured to take advantage of the net force due to the surface tension provided by the hydrophilic wedge.

The minimum width 44 may be smaller than the size of the droplet 2 the device 1 is configured to manipulate. The maximum width 43 may also be smaller than the size of the droplet 2 the device 1 is configured to manipulate. For example, if the device 1 is configured to manipulate droplets with a diameter of D, the minimum width 44 of the track may be less than 0.7 D, e.g. less than 0.3 D, and the maximum width 43 of the track may be less than 1 D, e.g. less than 0.6 D. In another example, the minimum width 44 of the track may be less than 0.5 D, e.g. less than 0.1 D, and the maximum width 43 of the track may be less than 1 D, e.g. less than 0.5 D.

The second parts of the track may be at least a factor 10 shorter than the first parts of the track, e.g. at least at least a factor 100 shorter than the first parts of the track.

The guiding pattern may alternatively or additionally comprise a first and a second separate patch, the first and second separate patches being guiding regions of the least one guiding region of the surface, the first and second separate patches being separated from each other by the hydrophobic region,
wherein the ultrasound transducer array is configured to actuate the motion of the droplet from the first separate patch, via the hydrophobic region, to the second separate patch,
whereby the guiding pattern is configured to guide the droplet in motion by favoring movement of the droplet towards a location centrally over the second separate patch.

The guiding pattern may e.g. comprise a matrix of patches, the matrix of patches being guiding regions of the least one guiding regions of the surface, each patch of the matrix of patches being separated from other patches by the hydrophobic region, the first and second separate patch being comprised in the matrix of patches.

The guiding pattern may thus look like the track illustrated in FIG. 5, which will be referred to in the coming discussion. The first 51′ and second 51″ patches may be patches 51 surrounded by the hydrophobic region 12, thereby separated by the hydrophobic region 12. The first 51′ and second 51″ patches 51 may be guiding regions 14 which are hydrophobic, albeit less hydrophobic than the bordering hydrophobic region 12. Alternatively, the first 51′ and second 51″ patches 51 may be guiding regions 14 which are hydrophilic. Patches 51 of the guiding pattern 30 may have a size smaller than the size of the droplet the device is configured to manipulate. For example, if the device is configured to manipulate droplets with a diameter of D, the size of patches 51 in the guiding pattern 30 may be less than 0.7 D, e.g. less than 0.3 D. According to another example, the size of patches 51 in the guiding pattern 30 may be less than 0.5 D, e.g. less than 0.2 D. The term “size of the patch” may herein refer to a diameter of the patch 51 or the largest lateral extension of the patch 51.

When the guiding pattern favors movement of the droplet towards a location centrally over the second separate patch the guiding pattern may correct the movement of the droplet. The droplet may preferentially stay centrally above the patch, due to the difference in hydrophobicity between the patch and the surrounding hydrophobic region. If the ultrasound transducer array moves the droplet slightly off center of the patch, the patch may pull the droplet towards the center as the droplet may have a greater affinity to the patch than to the surrounding hydrophobic region. Thus, a series of patches may form a path for the droplet. The ultrasound transducer array may move the droplet from one patch to another and for every patch the movement of the droplet may be corrected such that it stays on the path. Thereby, the requirements on the movement resolution achievable by the ultrasound transducer array alone may be relaxed as the patches help to correct the movement.

As mentioned, the guiding pattern may comprise a matrix of patches. Thus, there may be several alternative paths for the droplet to move along depending on how it is steered by the ultrasound transducer array. However, the patches may ensure that there is a finite number of paths, given by the different combinations of movements wherein the droplet is only allowed to move to adjacent patches. A finite number of paths may simplify the calculations needed to control the ultrasound transducer array and thereby save cost and computing power.

The hydrophobic region may be super-hydrophobic. At least one of the at least one guiding region may be hydrophobic. At least one of the at least one guiding region may be super-hydrophobic. As previously mentioned, the droplet may move more easily along a hydrophobic surface, e.g. roll along hydrophobic surface. The droplet may move particularly easy along a super-hydrophobic surface. At the same time, at an interface between a more hydrophobic and a less hydrophobic surface, the droplet may be hindered or prevented from moving into the more hydrophobic region. At least one of the at least one guiding region may be hydrophilic. A hydrophilic surface may facilitate interaction between matter in the droplet and matter on the surface, e.g. facilitate interaction between cells suspended in the droplet with antibodies attached to the hydrophilic surface. Further, a hydrophilic surface may facilitate mixing of droplets. A hydrophilic patch, e.g. a large hydrophilic patch, can be used as a stationary fluid well such that a pulsatile acoustic radiation force can be imparted directly on the top of a merged droplet to induce acoustic streaming or turbulence of fluid inside the merged droplet and accelerate mixing beyond just passive diffusion. A definition of a hydrophilic surface may be: a surface on which a pure water droplet forms a contact angle to the surface of less than 90 degrees. A definition of a hydrophobic surface may be: a surface on which a pure water droplet forms a contact angle to the surface of more than 90 degrees. A definition of a super-hydrophobic surface may be: a surface on which a pure water droplet forms a contact angle to the surface of more than 150 degrees.

At least one of the hydrophobic region and the at least one guiding region may comprise pillars of sub millimeter size. The pillars may be micro pillars or nanowires, e.g. pillars with a diameter below 100 μm, below 10 μm, or below 1 μm. The pillars may form a surface structure that, at least partially, defines the hydrophobicity of the surface. The hydrophobicity may herein depend on the length of the pillars. The hydrophobicity may alternatively or additionally depend on the width of the pillars. The hydrophobicity may alternatively or additionally depend on the surface density of the pillars. Thus, by changing pillar length and/or pillar width and/or pillar surface density from one region to another, e.g. from a guiding region to a hydrophobic region the hydrophobicity of the regions may be defined. The surface may thus be manufactured from a cheap substrate, e.g. glass, and the hydrophobicity of the regions of the surface may be defined by etching pillars of different length and/or surface density in the different regions.

The hydrophobicity may of course not solely depend on the surface morphology, it may additionally or alternatively depend on the chemical composition of the surface. Fluorinated surface treatment may make a region more hydrophobic. Pillars may be combined with chemical treatment of the surface, e.g. fluorinated surface treatment, to set the hydrophobicity. The surface may need to be non-flat, e.g. comprise pillars, to become super-hydrophobic.

The guiding pattern of the surface of the device may comprise a plurality of alternative paths of the droplet along the surface of the device, the device may further comprise a path selector, the path selector being configured to receive an input signal indicating a chosen path of the plurality of alternative paths, wherein the device is configured to modify, in time, the acoustic radiation force applied to the droplet by the ultrasound transducer array to transport the droplet along the chosen path of the plurality of alternative paths.

Thus, the device may be programmable. The path selector may e.g. be a processor which receives an input signal in the form of instructions of how the droplet should be moved, e.g. at the crossing between a first track, a second track and a third track move the droplet from the first track to the third track, thereby selecting that path. The path selector may then control the ultrasound transducer array such that it transports the droplet accordingly.

According to a second aspect of the present inventive concept there is provided a surface configured to be arranged under and separate from an ultrasound transducer array, the surface being configured to support a droplet comprising water, the surface comprising a hydrophobic region and at least one guiding region, wherein the at least one guiding region has a lower hydrophobicity than the hydrophobic region, such that the droplet has a greater affinity to the at least one guiding region than to the hydrophobic region, whereby the hydrophobic region and the at least one guiding region form a guiding pattern of the surface, wherein the surface is configured to guide motion of the droplet along the surface by the guiding pattern, the motion of the droplet being motion actuated by ultrasound emitted from the ultrasound transducer array.

According to a third aspect of the present inventive concept there is provided a biosensor configured to identify a biological component, the biosensor comprising:
a reagent, the reagent being configured to react with the biological component; and
a device according to the first aspect, the device being configured to manipulate a droplet comprising water and the biological component to a location of the reagent or the reagent to a location of the biological component, whereby the biological component and the reagent reacts and the biological component is identified.

The biological component may be e.g. a cell, a biomolecule, DNA, RNA, or an antigen. The reagent may be e.g. antibodies or nanoparticles The biosensor may be e.g. an enzyme-linked immunosorbent assay (ELISA), a surface plasmon resonance biosensor, or a quantitative polymerase chain reaction (qPCR) biosensor.

A surface according to the second aspect and a biosensor according to the third aspect may have the same advantages, or similar advantages, as the device according to the first aspect.

### BRIEF DESCRIPTION OF THE DRAWINGS

The above, as well as additional objects, features and advantages of the present inventive concept, will be better understood through the following illustrative and non-limiting detailed description, with reference to the appended drawings. In the drawings like reference numerals will be used for like elements unless stated otherwise.

FIG. 1 illustrates a device in the form of a biosensor.

FIG. 2 illustrates a track.

FIG. 3 illustrates a track.

FIG. 4 illustrates a track.

FIG. 5 illustrates a matrix of patches.

FIG. 6 illustrates a cross-section of a surface.

FIG. 7 illustrates a focused ultrasound field on a droplet.

FIG. 8 illustrates a focused ultrasound field on a droplet.

FIG. 9 illustrates a droplet in a trapping potential.

### DETAILED DESCRIPTION

In cooperation with attached drawings, the technical contents and detailed description of the present invention are described hereinafter according to a preferable embodiment, being not used to limit the claimed scope. This invention may be embodied in many different forms and should not be construed as limited to the embodiments set forth herein; rather, these embodiments are provided for thoroughness and completeness, and fully convey the scope of the invention to the skilled person.

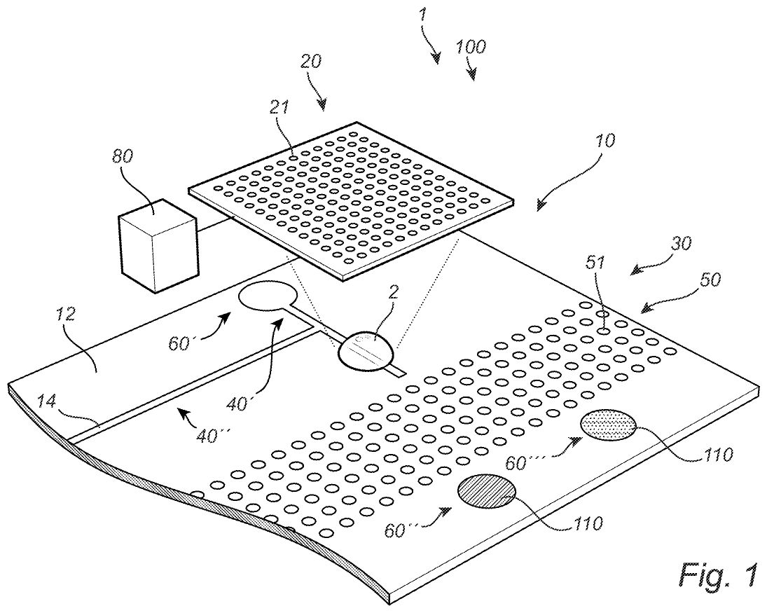

FIG. 1 illustrates a device 1 for manipulating a droplet 2 comprising water. The device 1 comprises a surface 10 configured to support the droplet 2 and an ultrasound transducer array 20. The ultrasound transducer array 20 comprises ultrasound transducers 21, e.g. micromachined ultrasound transducers 21 such as e.g. piezoelectric micromachined ultrasound transducers 21 or capacitive micromachined ultrasound transducers 21. The ultrasound transducer array 20 is arranged above the surface and separated from the surface. Thus, there may be a free space between at least some of the ultrasound transducers 21 and the surface 10. The ultrasound transducer array 20 may of course be connected to a side wall, which in turn is connected to the surface 10. The side wall may herein be arranged such that it does not obstruct a free line of sight between the ultrasound transducer array 20 and the surface 10.

In the device of FIG. 1, the surface 10 comprises a hydrophobic region 12 and several guiding regions 14 of lower hydrophobicity. The illustrated guiding regions 14 form a guiding pattern 30 comprising a first 40′ and second 40″ track and a matrix 50 of patches 51. In the figure the surface 10 further comprises several reservoir regions 60. The droplet 2 may thus be moved between reservoir regions 60 via the guiding regions 14. The guiding pattern 30 herein comprises a plurality of alternative paths for the droplet 2 to move along on the surface 10 of the device 1. The droplet may e.g. move from a first reservoir region 60′ along the first track 40′. At the crossing between the first 40′ and second 40″ track the droplet may continue on the first track 40′ or turn into the second track 40″. A path selector 80 may receive an input signal in the form of instructions of how the droplet should be moved at the crossing and control the ultrasound transducer array 20 such that it forces the droplet 2 to be moved accordingly. The path selector 80 may be e.g. a processor or an application-specific integrated circuit.

In the device 1 of FIG. 1 a droplet 2 may be moved from a first reservoir region 60′ to a second 60″ or third 60′″ reservoir region. In the device of FIG. 1, the second 60″ and third 60′″ reservoir region comprises a reagent 110 each, the reagents 110 being different from each other. The reagents 110 may herein be antibodies attached to the surface 10 in the second 60″ and third 60′″ reservoir region. When a droplet 2 comprising water and a biological component, e.g. a cell or a protein, is transported to the second 60″ or third 60′″ reservoir region, the biological component may react with the reagent and the biological component may be detected. For example, the droplet 2 may carry biological cells marked with fluorescent markers. If the cells become immobilized as the droplet is manipulated over a region coated with antibodies the cells may be identified as cells of a type corresponding to said antibody.

A device 1 comprising a reagent 110 for identifying a biological component may be considered to be a biosensor 100. It should be understood that in a biosensor 100 the reagent 110 does not need to be attached to the surface 10 of a reservoir region 60 like the antibodies in the above example. The reagent 110 may alternatively be attached to the surface of a guiding region 14 or not attached to the surface 10 at all. The reagent 110 may be comprised in a liquid droplet, e.g. in a droplet 2 comprising water. As an alternative to manipulating a droplet 2 comprising water and the biological component to a location of the reagent 110, a droplet 2 comprising water and the reagent 110 may be manipulated to a location of the biological component.

It should be understood that a device 1 according to the inventive concept does not necessarily need to be a biosensor 100, it may e.g. be a chemical sensor which manipulates droplets 2 comprising water and a chemical component, whereby the chemical component may be identified. The device does not need to be a sensor at all, it may be configured to transport and/or mix droplets 2 comprising water. The device 1 does not necessarily need to comprise reservoir regions 60. The device 1 does not necessarily need to comprise a reagent 110.

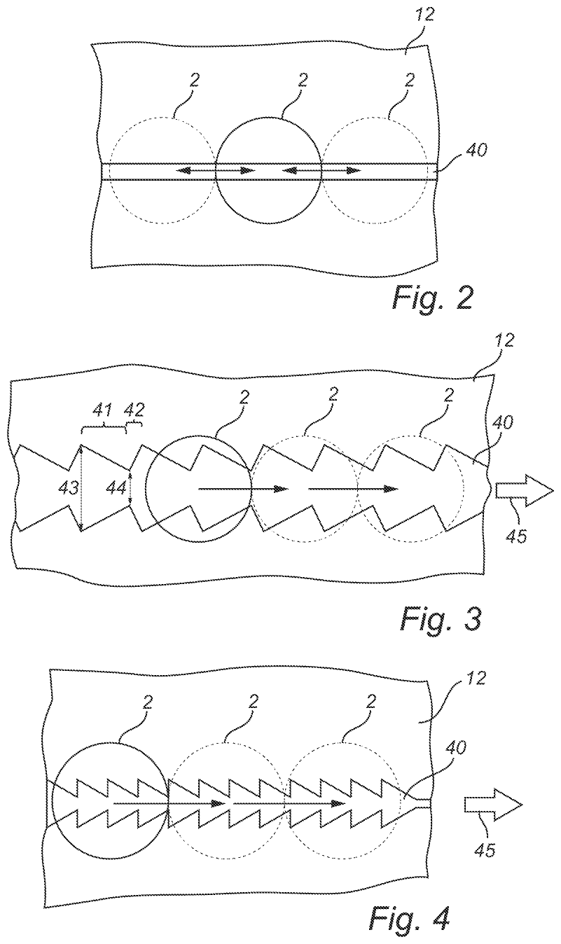

FIG. 2 illustrates a track 40 wherein the droplet 2 may move equally easily forward and backwards along the track 40. A current position of the droplet 2 is illustrated with a solid line while future possible positions are illustrated with dashed lines. The illustrated track 40 has a uniform width, in this case smaller than the diameter of the droplet 2. The track 40 has a lower hydrophobicity than the surrounding hydrophobic region 12. The track 40 may e.g. be super-hydrophobic with a contact angle to water of 150 degrees, or more. The hydrophobic region 12 may e.g. be super-hydrophobic with a contact angle to water of at least 1 degree more, or at least 5 degrees more, than the contact angle for the track 40. Alternatively, the track 40 may be hydrophobic with a contact angle to water below 150 degrees, e.g. 100 degrees, while the hydrophobic region 12 may be super-hydrophobic.

FIGS. 3 and 4 illustrate tracks 40 which are configured to favor movement of the droplet 2 in one direction 45 along the length of the track 40. A current position of the droplet 2 is illustrated with a solid line while future possible positions are illustrated with dashed lines. Thus, the droplets 2 in FIGS. 3 and 4 preferentially move to the right. In FIG. 3, the track 40 narrows slowly from a maximum width 43 to a minimum width 44 in the first part 41 of the track 40, and then widens abruptly from the minimum width 44 to the maximum width 43 in the second part 42 in the direction 45 along the length of the track 40. Thus, the droplet 2 may preferentially move in said direction 45. It should be understood that the second part 42 of the track 40 may be infinitesimally small, as exemplified in FIG. 4. A track 40 configured to favor movement of the droplet 2 in one direction 45 has a lower hydrophobicity than the surrounding hydrophobic region 12. The track 40 may e.g. be super-hydrophobic with a contact angle to water of 150 degrees, or more. The hydrophobic region 12 may e.g. be super-hydrophobic with a contact angle to water of at least 1 degree more, or at least 5 degrees more, than the contact angle for the track 40. Alternatively, the track 40 may be hydrophobic with a contact angle to water below 150 degrees, e.g. 100 degrees, while the hydrophobic region 12 may be super-hydrophobic.

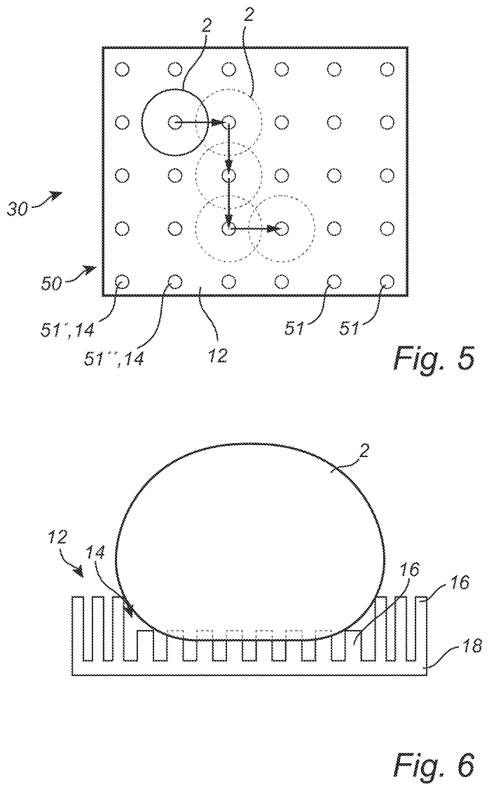

FIG. 5 illustrates a matrix 50 of patches 51, wherein each patch 51 is a guiding region 14 surrounded by the hydrophobic region 12. Any two adjacent patches 51 may be seen as a first 51′ and second 51″ patch. The ultrasound transducer array 20 may be configured to actuate the motion of the droplet 2 from the first separate patch 51′, via the hydrophobic region 12, to the second separate patch 51″. The droplet 2 may thus be moved between different patches 51, as illustrated in the figure where a current position of the droplet 2 is illustrated with a solid line while future possible positions are illustrated with dashed lines. The patches 51 have a lower hydrophobicity than the surrounding hydrophobic region 12. The patches 51 may e.g. be super-hydrophobic with a contact angle to water of 150 degrees, or more. The hydrophobic region 12 may e.g. be super-hydrophobic with a contact angle to water of at least 1 degree more, or at least 5 degrees more, than the contact angle for the patches 51. Alternatively, the patches 51 may be hydrophobic with a contact angle to water below 150 degrees, e.g. 100 degrees, while the hydrophobic region 12 may be super-hydrophobic. Alternatively, the patches 51 may be hydrophilic while the hydrophobic region 12 may be super-hydrophobic.

The surface 10 in any of the above examples may be glass. The hydrophobicity of the surface in the hydrophobic region 12 and the guiding region 14 may be at least partially defined by the surface morphology. For example, the hydrophobic region 12 and the at least one guiding region 14 may comprise pillars 16 of sub millimeter size, formed on a substrate 18, as illustrated in a cross-section of the surface in FIG. 6. The figure illustrates a droplet 2 in a guiding region 14 comprising short, wide pillars 16, with a low pillar surface density. The illustrated guiding region 14 has one hydrophobic region 12 to the left and one to the right, wherein both hydrophobic regions 12 comprise long, thin pillars 16, with a high pillar surface density. Thus, the hydrophobicity of the surface may depend on the pillar size and pillar surface density. Thinner pillars 16 may result in a higher hydrophobicity. Longer pillars 16 may result in a higher hydrophobicity. A higher pillar surface density may result in a higher hydrophobicity. The hydrophobicity of the illustrated guiding region 14 may correspond to a contact angle to water of 150 degrees, or more. The hydrophobicity of the illustrated hydrophobic region 12 may correspond to a contact angle to water of at least 1 degree more, or at least 5 degrees more, than the contact angle to water of the guiding region 14. The hydrophobicity may alternatively or additionally depend on the chemical composition of the surface. The pillars 16 may be etched into a coating on the surface, wherein the coating has a hydrophobicity arising from the chemical composition. The coating may be formed from by a fluorinated surface treatment of a glass surface.

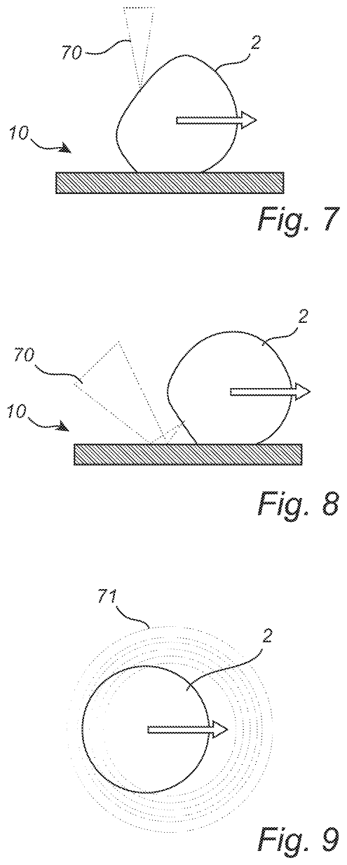

The ultrasound transducer array 20 may be an ultrasound transducer phased array, wherein the phases of at least a subset of the ultrasound transducers are adjustable. Thus, the ultrasound beam may be shaped and/or steered. The ultrasound transducer array 20 may actuate a motion of the droplet 2 along the surface 10 by focusing the ultrasound field 70. For example, as illustrated in FIG. 7, the ultrasound field 70 may be focused on one side of the droplet 2, whereby the droplet 2 may be subjected to an acoustic radiation force pushing the droplet 2 in the direction of the opposite side. As illustrated in FIG. 8 the ultrasound field 70 may be focused on the droplet 2 via a reflection on the surface 10, whereby the droplet is pushed from below.

The ultrasound transducer array 20 may actuate a motion of the droplet 2 along the surface 10 by applying an acoustic radiation force to the droplet through trapping the droplet 2 in an acoustic trapping potential 71, generated by the ultrasound transducer array 20, and moving the acoustic trapping potential 71. FIG. 9 illustrates a droplet 2 in a trapping potential 71. The illustrated trapping potential 71 is a ring-shaped potential wherein the ultrasound field has a maximum pressure region forming a ring around the droplet 2. Thus, a ring-shaped wall of increased potential may surround a lower potential inside the ring. When the wall moves the droplet 2 inside may be pushed along. The shape of the trapping potential 71 does not necessarily need to be ring-shaped, it may e.g. be a quadratic potential, or a gaussian potential. The acoustic trapping potential may be a minimum, e.g. local minimum, in an acoustic potential. The acoustic trapping potential 71 may be formed by the ultrasound transducer array 20 according to the principles of acoustic tweezers. The acoustic trapping potential 71 may be formed by a standing wave between the ultrasound transducer array 20 and the surface 10.

In the above the inventive concept has mainly been described with reference to a limited number of examples. However, as is readily appreciated by a person skilled in the art, other examples than the ones disclosed above are equally possible within the scope of the inventive concept, as defined by the appended claims.

1. A device for manipulating a droplet comprising water, the device comprising:
a surface configured to support the droplet, the surface comprising a hydrophobic region; and
an ultrasound transducer array, the ultrasound transducer array being arranged above the surface, and separated from the surface; wherein the ultrasound transducer array is configured to emit ultrasound for actuating a motion of the droplet along the surface by subjecting the droplet to an acoustic radiation force by the emitted ultrasound.

2. The device of claim 1, wherein the surface of the device further comprises at least one guiding region, wherein the at least one guiding region has a lower hydrophobicity than the hydrophobic region, such that the droplet has a greater affinity to the at least one guiding region than to the hydrophobic region, whereby the hydrophobic region and the at least one guiding region form a guiding pattern of the surface, wherein the surface is configured to guide motion of the droplet along the surface by the guiding pattern.

3. The device of claim 2, wherein the guiding pattern comprises a track, the track having a width and a length, the length being larger than the width, the track being one of the at least one guiding regions of the surface, wherein the hydrophobic region of the surface borders the track on both sides of the track, along the length of the track,
whereby the guiding pattern is configured to guide the motion of the droplet by favoring movement of the droplet along the track.

4. The device of claim 3, wherein the track is formed by a periodical repetition of a first part of the track and a second part of the track along the length of the track,
wherein, in a direction along the length of the track, the width of the track narrows, in the first part of the track, from a maximum width to a minimum width, after which the width of the track widens, in the second part of the track, from the minimum width to the maximum width, and
wherein, in the periodical repetition, the second parts of the track are shorter than the first parts of the track.

5. The device of claim 2, wherein the guiding pattern comprises a first separate patch and a second separate patch, the first and second separate patches being guiding regions of the least one guiding region of the surface, the first and second separate patches being separated from each other by the hydrophobic region, and
wherein the ultrasound transducer array is configured to actuate the motion of the droplet from the first separate patch, via the hydrophobic region, to the second separate patch,
whereby the guiding pattern is configured to guide the droplet in motion by favoring movement of the droplet towards a location centrally over the second separate patch.

6. The device of claim 5, wherein the guiding pattern comprises a matrix of patches, the matrix of patches being guiding regions of the least one guiding regions of the surface, each patch of the matrix of patches being separated from other patches by the hydrophobic region, and wherein the matrix of patches comprises the first and second separate patches.

7. The device of claim 1, wherein the hydrophobic region is super-hydrophobic.

8. The device of claim 2, wherein at least one guiding region of the at least one guiding region is hydrophobic.

9. The device of claim 2, wherein at least one guiding region of the at least one guiding region is hydrophilic.

10. The device of claim 2, wherein the hydrophobic region and the at least one guiding region comprise pillars of sub millimeter size.

11. The device of claim 1, wherein the device is configured to actuate the motion of the droplet by applying an acoustic radiation force to the droplet by focusing an ultrasound field from the ultrasound transducer array on the droplet.

12. The device of claim 1, wherein the device is configured to actuate the motion of the droplet by applying an acoustic radiation force to the droplet by trapping the droplet in an acoustic trapping potential that is generated by the ultrasound transducer array, and moving the acoustic trapping potential.

13. The device of claim 2, wherein the guiding pattern of the surface comprises a plurality of alternative paths for the droplet to move along on the surface of the device, the device further comprising a path selector, the path selector being configured to receive an input signal indicating a chosen path of the plurality of alternative paths, and
wherein the device is configured to modify, over time, the acoustic radiation force applied to the droplet by the ultrasound transducer array to transport the droplet along the chosen path of the plurality of alternative paths.

14. A surface configured to be arranged under and separate from an ultrasound transducer array, the surface being configured to support a droplet comprising water, the surface comprising a hydrophobic region and at least one guiding region, wherein the at least one guiding region has a lower hydrophobicity than the hydrophobic region, such that the droplet has a greater affinity to the at least one guiding region than to the hydrophobic region, whereby the hydrophobic region and the at least one guiding region form a guiding pattern of the surface, and wherein the surface is configured to guide motion of the droplet along the surface by the guiding pattern, the motion of the droplet being motion actuated by ultrasound emitted from the ultrasound transducer array.

15. A biosensor configured to identify a biological component, the biosensor comprising:
a reagent configured to react with the biological component; and
a device configured to manipulate a droplet comprising water, the device comprising:
a surface configured to support the droplet, the surface comprising a hydrophobic region; and
an ultrasound transducer array, the ultrasound transducer array being arranged above the surface, and separated from the surface; wherein the ultrasound transducer array is configured to emit ultrasound for actuating a motion of the droplet along the surface by subjecting the droplet to an acoustic radiation force by the emitted ultrasound,
wherein the device is configured to at least one of: (i) manipulate the droplet to a location of the reagent when the droplet contains the biological component, or (ii) manipulate the droplet to a location of the biological component when the droplet contains the reagent, whereby the biological component and the reagent and the biological component is identified.

16. The biosensor of claim 15, wherein the surface of the device further comprises at least one guiding region, wherein the at least one guiding region has a lower hydrophobicity than the hydrophobic region, such that the droplet has a greater affinity to the at least one guiding region than to the hydrophobic region, whereby the hydrophobic region and the at least one guiding region form a guiding pattern of the surface, wherein the surface is configured to guide motion of the droplet along the surface by the guiding pattern.

17. The biosensor of claim 16, wherein the guiding pattern comprises a track, the track having a width and a length, the length being larger than the width, the track being one of the at least one guiding regions of the surface, wherein the hydrophobic region of the surface borders the track on both sides of the track, along the length of the track,
whereby the guiding pattern is configured to guide the motion of the droplet by favoring movement of the droplet along the track.

18. The biosensor of claim 17, wherein the track is formed by a periodical repetition of a first part of the track and a second part of the track along the length of the track,
wherein, in a direction along the length of the track, the width of the track narrows, in the first part of the track, from a maximum width to a minimum width, after which the width of the track widens, in the second part of the track, from the minimum width to the maximum width, and
wherein, in the periodical repetition, the second parts of the track are shorter than the first parts of the track.

19. The biosensor of claim 16, wherein the guiding pattern comprises a first separate patch and a second separate patch, the first and second separate patches being guiding regions of the least one guiding region of the surface, the first and second separate patches being separated from each other by the hydrophobic region, and
wherein the ultrasound transducer array is configured to actuate the motion of the droplet from the first separate patch, via the hydrophobic region, to the second separate patch,
whereby the guiding pattern is configured to guide the droplet in motion by favoring movement of the droplet towards a location centrally over the second separate patch.

20. The biosensor of claim 19, wherein the guiding pattern comprises a matrix of patches, the matrix of patches being guiding regions of the least one guiding regions of the surface, each patch of the matrix of patches being separated from other patches by the hydrophobic region, and wherein the matrix of patches comprises the first and second separate patches.
